(19) United States
(12) Patent Application Publication
(10) Pub. No.: US 2002/0128109 A1
(43) Pub. Date: Sep. 12, 2002

(54) Computerized variable speed planetary drive system for motorized machines

(76) Inventor: Geno Francis Mancini, Mt. Iron, MN (US)

Correspondence Address: Geno Francis Mancini, 10222 Hwy 92, Mt. Iron, MN, 55768, US

(21) Appl. No.: 09/757,795

(22) Filed: Jan. 11, 2001

(51) Int. Cl. F16H 47/08

(52) U.S. Cl. 475/210

(57) ABSTRACT

A computerized variable speed planetary drive system includes a planetary gear set, two pulleys connected by a cogged drive belt which is connected to the drive axle. The drive system is controlled by an onboard computer which operates a servo motor coupled to a brake master cylinder. The brake master cylinder applies hydraulic pressure to a disk brake caliper which controls the speed of the rotating propel disk which in turn controls the speed of the vehicle.

### REFERENCES CITED [REFERENCED BY]

U.S. Patent Documents

| | | | |
|---|---|---|---|
| 4301884 | Nov., | 1981 | Taylor. |
| 5033572 | | 1991 | Zulawski |
| 5014805 | May., | 1991 | Uchida. |
| 5060745 | Oct., | 1991 | Yasui et al. |

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

1. Field of Invention

This invention relates to power transmission systems and in particular to a computerized variable speed planetary drive system for use with belt, shaft or chain driven vehicles, such as employed in snowmobiles, all-terrain vehicles or similar lightweight vehicles.

2. Description of Prior Art

Motorized machines requiring a variable transmission comprising a primary drive sheave, a V-belt, and the secondary drive sheave have the disadvantage of drive belt slippage and drive belt wear. These machines also incorporate a jackshaft for transmitting power to the drive axle through an interconnecting pair of sprockets and an endless chain. Accordingly, there have been many problems associated with this type of arrangement. Clearly there is a need for a reliable, lightweight, efficient, safer drive system for motorized machines.

Typical prior art drive systems used on a snowmobile, for example, are shown in U.S. Pat. No. 4,301,884 to Taylor (1981), and U.S. Pat. No. 5,033,572 to Zulawski (1991). In existing prior art systems a drive clutch, drive belt, driven clutch, jackshaft, bearings, brake components, interconnecting pair of sprockets and drive chain are located high on a chassis, causing a very high center of gravity. This results in a poor handling, unsafe machine with undesirable performance characteristics. In addition the prior art has not provided a safe reliable braking system, due in part to locating a brake rotor on the jackshaft, instead of on the drive axle. Therefore, if the jackshaft or drive chain breaks, the machine can not be stopped in a timely manner.

### SUMMARY OF THE INVENTION

A computerized variable speed planetary drive system for motorized machines. The planetary drive system consists of an inner sun gear, planet gears which are meshed around the sun gear, and an outer ring gear meshed around the planet gears. A propel disk is affixed to the ring gear. This entire unit mounts on the end of the engine crankshaft. The crankshaft is affixed to the sun gear by means of a tapered press fit. As the engine rotates, the sun gear rotates at the same speed. This rotation also rotates the planet gears, but not the planet carrier that the planet gears are affixed to. As the planet gears spin, they force the ring gear, which is mounted around the planet gears, to also spin. The propel disk affixed to the ring gear, rotates with the ring gear. In this condition, the machine is in neutral.

When the operator of the machine wants to start forward motion, the throttle is depressed and the engine starts to increase in rpm. The computer monitors the engine rpm, drive axle rpm and the position of the throttle and outputs the command to the servo motor to start to turn. The servo motor is coupled to a hydraulic brake master cylinder. As this hydraulic brake master cylinder is activated, it causes the pressure in the hydraulic brake line to increase. The hydraulic brake line is connected to a hydraulic disk brake caliper, which is mounted over the spinning propel disk. As the disk brake caliper starts to close and applies friction to the propel disk, the disk begins to slow down. This slowing down of the propel disk forces the planet carrier to rotate. The planet carrier is connected to the drive pulley. A cogged gear belt connects the drive pulley to the driven pulley. The driven pulley is affixed to the drive axle, which propels the machine.

### OBJECTS AND ADVANTAGES

The constant ratio transmission currently being used in snowmobiles and all terrain vehicles, as shown for example in U.S. Pat. No. 5,014,805 to Uchida (1991) and U.S. Pat. No. 4,917,207 to Yasui (1990) are considered to be a very efficient, economical means of transmitting power. Several objects and advantages of the present invention are:

(a) to provide a drive system with such an arrangement as to create a low center of gravity to enhance the performance, ergonomics and safety of the whole vehicle;

(b) to provide a drive system which will utilize a safe, predictable, and reliable braking system for slowing and stopping the vehicle;

(c) to provide a drive system which will allow a very broad range of speed-to-power ratios available to enhance the performance of the machine;

(d) to provide a drive system which will locate the entire drive system, brake mechanism and related components away from the engine, therefore making the machine easier to repair and service;

(e) to provide a drive system which is controlled by a computer which has a twelve digit keypad to input parameters of which are;

(1) Engagement rpm, the rpm at which the vehicle starts to move.

(2) Peak rpm, the rpm at which the engine will operate at.

(f) to provide a drive system which can us e the engine as a means of deceleration;

### BRIEF DESCRIPTION OF THE DRAWINGS

An improved drive system for motorized vehicles and equipment constructed in accordance with this invention is described hereinbelow with reference to the accompanying drawings, wherein;

FIG. 1 is a side view of a snowmobile with portions broken away and portions shown in section, showing the arrangement of the drive system.

FIG. 2 is a top plan view showing the engine assembly arrangement with the interconnecting drive means assemble rotated 90 degrees for clear viewing with a portion of the chassis and other components.

FIG. 3 is a side view of the planetary drive unit, drive belt, driven pulley, brake disk, brake caliper, and drive axle.

FIG. 4 is a layout view of the planetary drive unit which is mounted on the engine crankshaft.

FIG. 5 is a layout view of the driven pulley, brake disk, brake caliper and drive axle of the snowmobile.

FIG. 6 is a block diagram of the electronics portion of the invention.

### DETAILED DESCRIPTION OF THE PREFERRED EMBODIMENT OF THE INVENTION

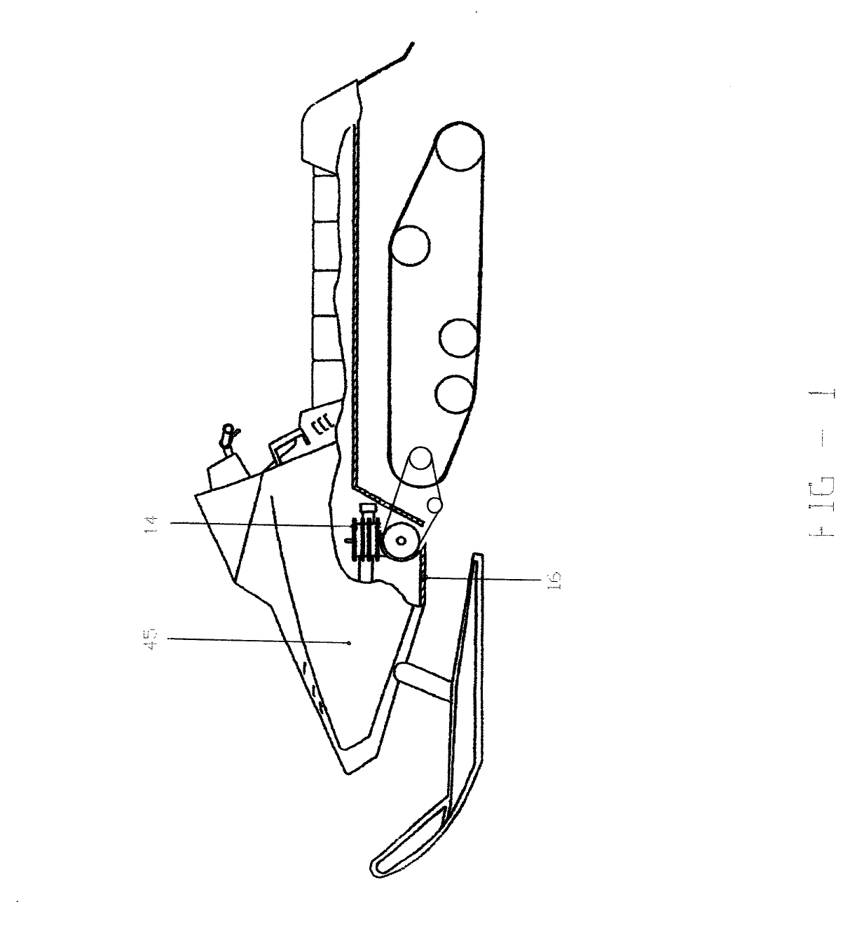

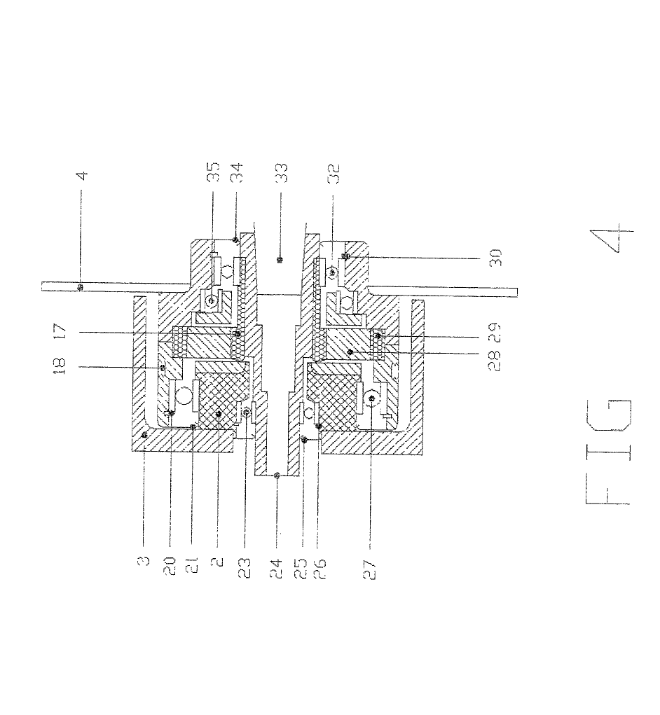

Referring now to FIG. 1, a power unit assembly 14, is typically attached to a chassis 16, of a motorized machine 45. Referring now to FIG. 4, a power unit assembly 14, (FIG. 1), drives an output shaft 33, which is pressed into a hollow shaft 24. This hollow shaft 24, has the sun gear 17, attached to it. Positioned around the sun gear 17, is the planet carrier 2, and supported by bearings 23, 27, 32 and 35. These bearings are held in place by snap rings 20, 26, and 30. The lubricating fluid is sealed inside with seals 21, 25, and 34. The lubricating fluid is filled through plug 18. As this sun gear 17, rotates, it in turn forces the planet gears 28, to rotate on their individual axis only. This rotation of the planet gears 28, forces the ring gear 29, to rotate. The propel disk 4, which is attached to the ring gear 29, rotates with the ring gear 29. In this condition, the vehicle is in neutral.

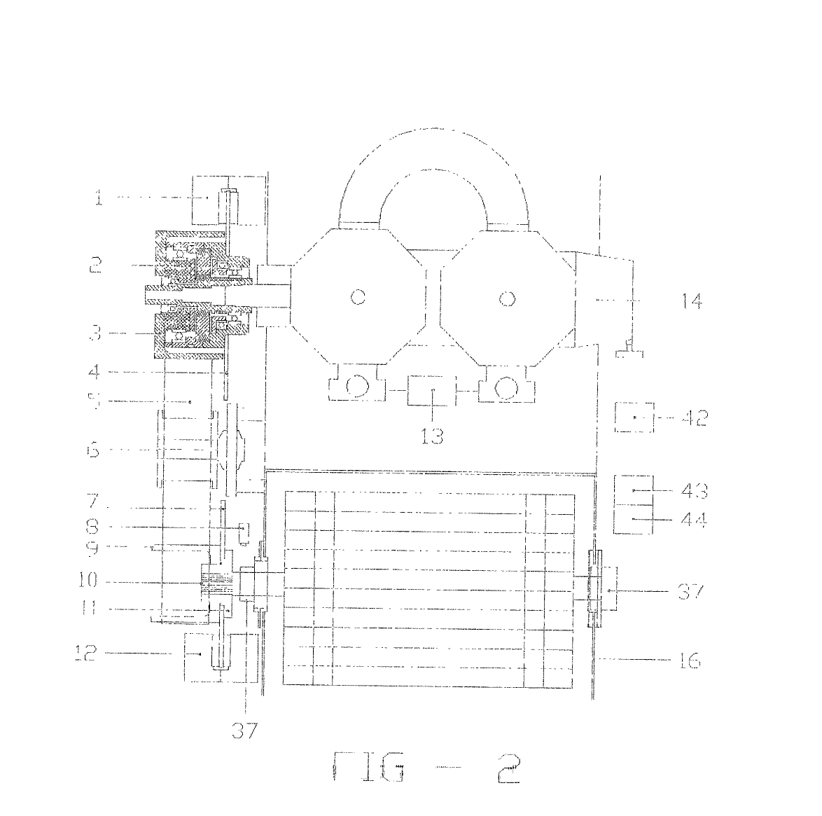

Referring now to FIG. 2, as the operator of the vehicle 45, (FIG. 1), increases the rpm of the power unit 14, the throttle position 13, of the power unit 14, is input in to the computer 42. The computer 42, then starts to rotate the servo motor 43, which in turn activates the master cylinder 44, which applies hydraulic pressure to the propel disk caliper 1. As this propel disk caliper 1, starts to squeeze together, it applies friction to the already rotating propel disk 4. This increase in friction on the propel disk 4, forces the ring gear 29, (FIG. 4) connected to it to slow down also. This reduction of speed on the ring gear 29, (FIG. 4), forces the planet carrier 2, to rotate. The drive pulley 3, attached to the planet carrier 2, also rotates. The drive pulley 3, attached to the planet carrier 2, drives the driven pulley 9, through a cogged drive belt 5. The driven pulley 9, attached to the driven hub 11, rotates the drive axle 10, which propels the vehicle.

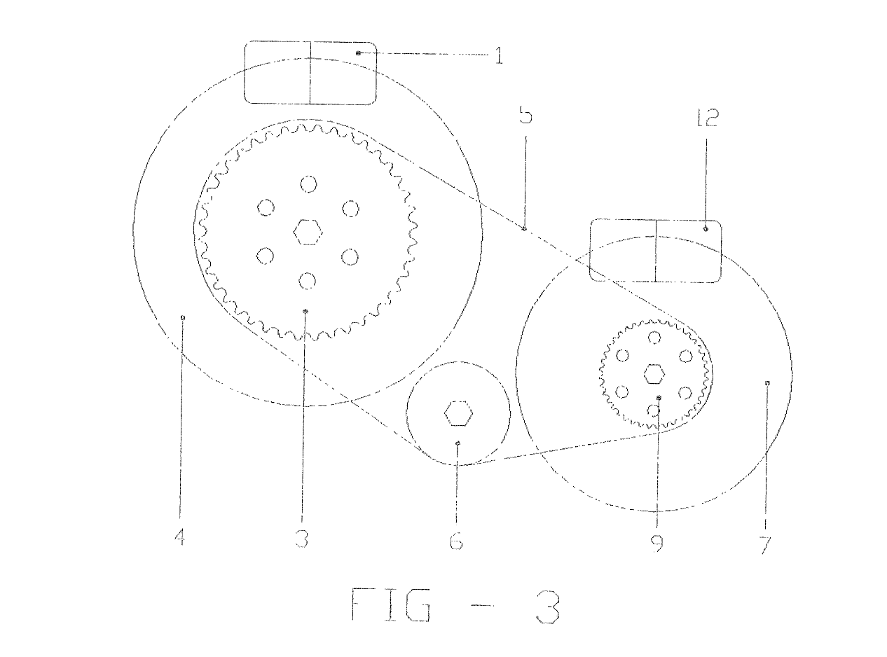

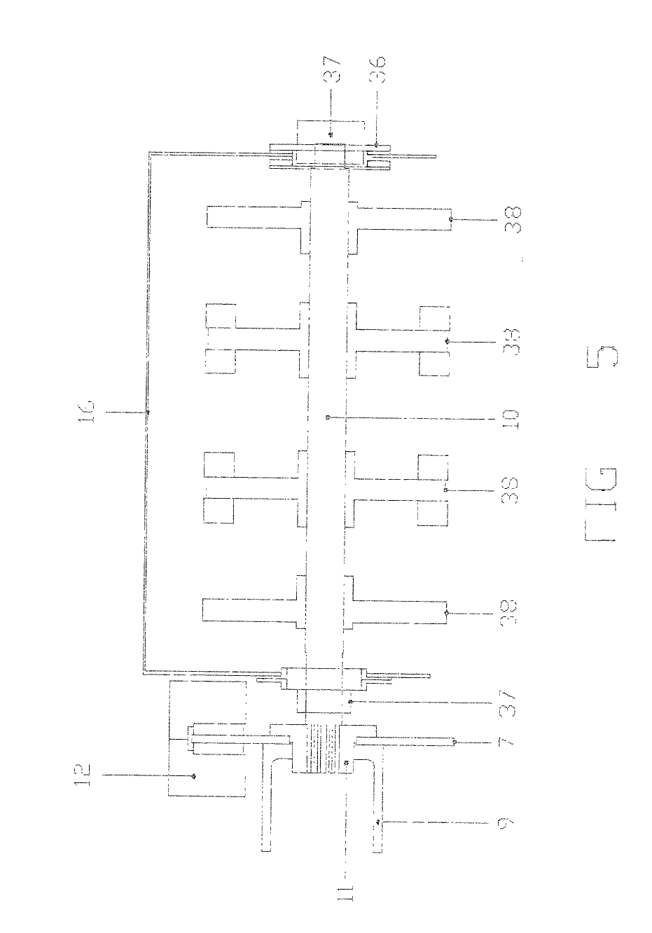

Referring now to FIG. 3, in neutral, the propel disk 4, is spinning. As the propel disk caliper 1, begins to slow the propel disk 4, the drive pulley 3, starts to rotate. This rotation forces the cogged drive belt 5, to rotate the driven pulley 9, which in turn rotates the drive axle 10, (FIG. 5) which propels the vehicle. The idler pulley 6, keeps the cogged drive belt 5, in tension. The brake disk caliper 12, positioned over the brake disk 7, attached to the drive axle 10, is used to slow or stop the vehicle.

Referring now to FIG. 5, the driven pulley 9, brake disk 7, are connected to the driven hub 11, which is attached to the drive axle 10, by way of a splined fitting. The drive axle 10, is inserted through the chassis 16, with bearings 37, on each end. On this drive axle 10, are the drive sprockets 38, which when rotated, propel the vehicle.

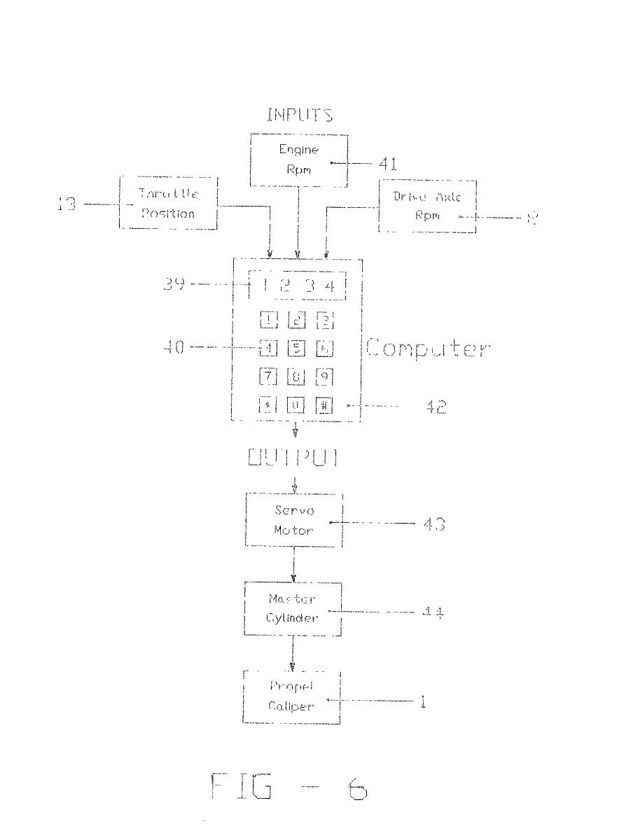

Referring now to FIG. 6, the throttle position 13, engine rpm 41, and drive axle rpm 8, are inputs for the onboard computer 42. With the 12 digit keypad 40, and 4 digit display 39, the operator can enter in the engagement rpm and operating rpm of the vehicle. With this information, the computer 42, can determine the position of the servo motor 43, which controls the master cylinder 44, which applies hydraulic pressure to the propel disk caliper 1.

What is claimed is:

1. A computerized variable speed planetary drive system comprising:
(a) an engine crankshaft mounted planetary gear set, which includes a liquid-tight casing operatively containing a lubricating transmission fluid, a sun gear and a ring gear directly meshing with each of the planet gears independently of each other, and a propel disk mounted to said ring gear, the rotary input drive being secured to the sun gear and the cogged drive pulley being secured to the planet carrier;
(b) a disk brake caliper positioned over the said propel disk for means of slowing or stopping said propel disk;
(c) a cogged drive belt connecting the said cogged drive pulley to a driven pulley on the drive axle;
(d) a brake disk positioned around said drive axle;
(e) a disk brake caliper positioned over said brake disk for means of slowing or stopping the vehicle;
(f) an idler pulley to keep the said cogged drive belt in tension;
(g) an onboard computer controlling a servo motor which is coupled to a brake master cylinder which applies hydraulic pressure to the said disk brake caliper which controls the speed of the said propel disk;
(h) an onboard computer program which allows the operator to input parameters comprising of engagement rpm, operating rpm and braking rpm;
(i) a printed circuit board for the said onboard computer.
